(19) United States
(12) Patent Application Publication
(10) Pub. No.: US 2009/0087302 A1
(43) Pub. Date: Apr. 2, 2009

(54) TURBOCHARGER

(75) Inventor: Alfred Grzonkowski, Mehlingen (DE)

Correspondence Address: BORGWARNER INC. C/O PATENT CENTRAL LLC, 1401 HOLLYWOOD BOULEVARD, HOLLYWOOD, FL, 33020-5237, US

(73) Assignee: Borg Warner Inc., Auburn Hills, MI (US)

(21) Appl. No.: 12/162,318

(22) PCT Filed: Jan. 31, 2007
(86) PCT No.: PCT/EP07/00834

§ 371 Date: Jul. 25, 2008

(30) Foreign Application Priority Data
Feb. 2, 2006 (DE) 10 2006 004 842.3

(51) Int. Cl. F02B 37/16; F01D 17/00

(52) U.S. Cl. 415/52.1; 415/145

(57) ABSTRACT

The invention relates to a turbocharger (1) comprising a turbine (2) and a compressor (3), connected to the turbine (2) so as to drive it and having a compressor housing (5) which has a by-pass channel (9) for connecting the compressor outlet with the compressor inlet and a diverter valve (10) which comprises a sealing element (11) having an obturator (12) and a valve face (13), the obturator (12) having a sealing lip (14).

The invention relates to a turbocharger as per the preamble of claim 1.

In turbocharged spark-ignition engines, in which the generic turbocharger can be used, the throttle flap which serves to predefine the engine load is fitted downstream of the compressor of the turbocharger in the air collector. When the throttle pedal is released, the throttle flap closes and the compressor of the turbocharger would, as a result of its mass inertia, feed air against a virtually closed volume. This would have the result that the compressor could no longer feed continuously, and backflows would form. The compressor would pump. The rotational speed of the turbocharger would therefore decrease very suddenly.

To prevent this, turbochargers can be provided with an air recirculation valve (also referred to as an overrun air recirculation valve) which, beyond a certain underpressure, opens a connecting duct in a pressure-controlled manner by means of a spring-loaded valve element, which connecting duct recirculates the air to the compressor inlet. It is thereby also possible for the rotational speed of the turbocharger to remain at a high level, and for charge pressure to be immediately available again in the event of a subsequent acceleration process.

A turbocharger corresponding to the preamble of claim 1 is known from DE 100 20041 C2. In said turbocharger, the valve closing part is formed as a diaphragm with an encircling sealing lip. Pressure and temperature loadings which act on said diaphragm, and the presence of aggressive engine blowby, lead to premature wear and premature failure of the diaphragm and therefore of the overrun air recirculation valve.

It is therefore an object of the present invention to create a turbocharger of the type specified in the preamble of claim 1 whose overrun air recirculation valve is more reliable.

Said object is achieved by means of the features of claim 1.

Subclaims 2 to 10 contain advantageous refinements of the invention.

The embodiment of the present invention no longer comprises a diaphragm as a valve closing part. Said diaphragm is replaced entirely either by a blocking element which has a sealing ring with an annular body, such as for example an O-ring body, or by a blocking element which has an annular body with a sealing lip, which blocking elements perform the sealing action against a conically tapering surface of the valve head. Said combination of axial and radial sealing equalizes tolerances at production depths and increases the reliability and security of the sealing action. As a result of the tapering sealing system, maximum sealing can be obtained in the deployed state (“closed” position) and minimum friction can be obtained in the retracted state (“open” position). The applied system pressure P2 increases the sealing capability as a result of a pressure on the sealing lip of the overrun air recirculation valve, and thereby also compensates possible abrasion losses.

In claim 11, an overrun air recirculation valve is defined as a separately marketable object.

Further details, advantages and features of the present invention can be gathered from the following description of an exemplary embodiment on the basis of the drawing, in which:

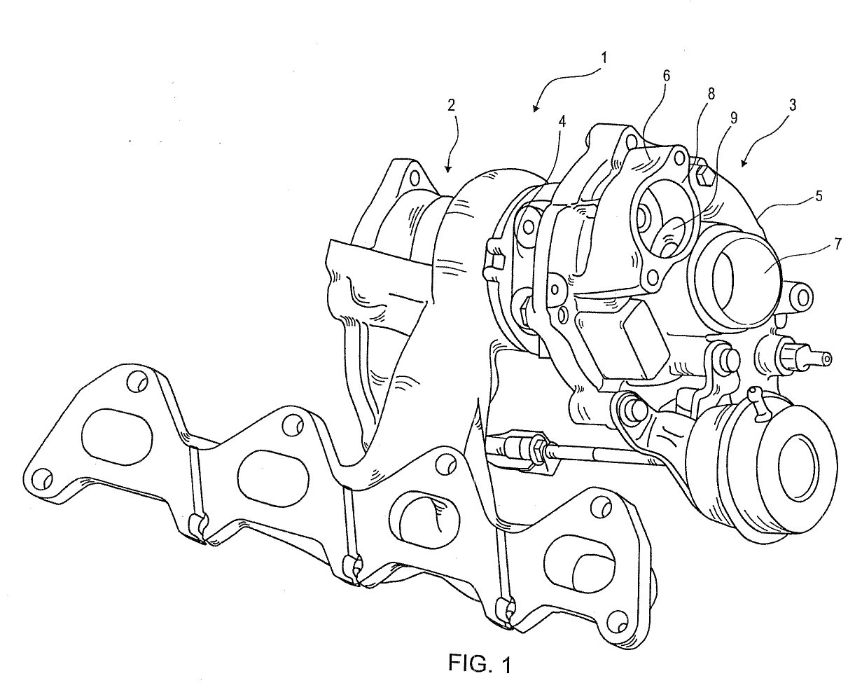

FIG. 1 shows a perspective illustration of a turbocharger according to the invention for explaining its basic design; and

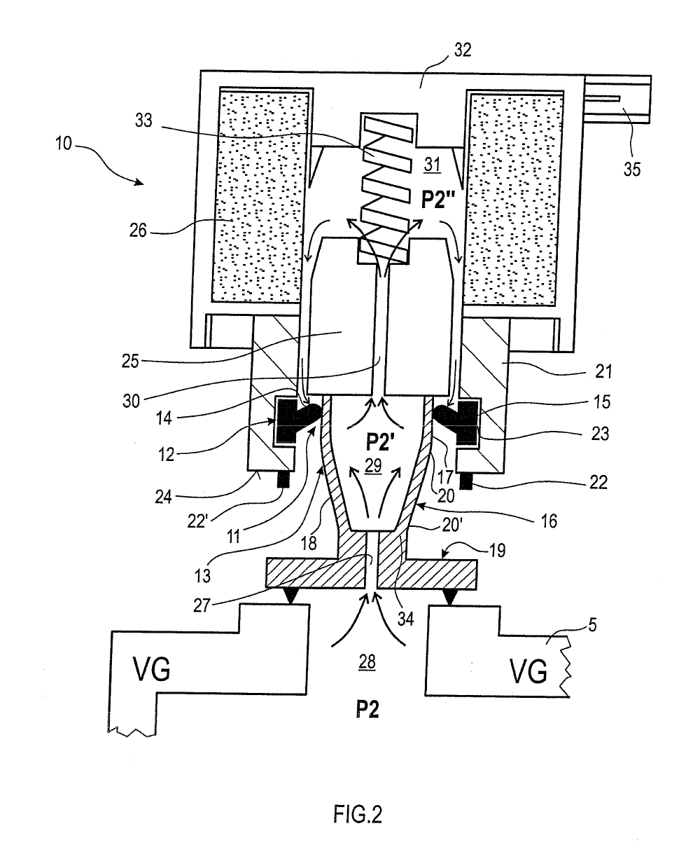

FIG. 2 shows a schematically slightly simplified section illustration through the overrun air recirculation valve for a turbocharger as per FIG. 1.

FIG. 1 serves to illustrate the basic components of a turbocharger 1 according to the invention which, as is conventional, has a turbine 2 and a compressor 3 which is connected to the turbine 2 by means of a bearing housing 4. All the other conventional components such as a rotor shaft, the compressor wheel and the turbine wheel are of course also provided, though these will not be explained in any more detail below since they are not necessary for the explanation of the principles of the present invention.

FIG. 2 illustrates the overrun air recirculation valve 5 according to the invention of the compressor 3 in a section illustration. The blocking element 12 illustrated in said figure has an annular body 15 on which an annular sealing lip 14 is arranged so as to point radially inward. In the illustration selected in FIG. 2, the sealing lip 14 is arranged so as to point upward at an acute angle with respect to the annular body 15.

The sealing lip 14 is part of a sealing device 11 which also has a valve sealing head 16 which has a cone section 18 which tapers, from a cylinder section 17, in the direction of the compressor housing 5 of the compressor 3.

The cylinder section 16 is adjoined in the direction of the compressor housing 5 by the cone section 18 which tapers, in the direction of the compressor housing 5, from one of its ends 20 with a diameter corresponding to that of the cylinder section 17 to an end 20′ with a smaller diameter.

The valve sealing head 16 also has a stop plate 19 which adjoins the end 20′ of the cone section 18 by means of a central cylindrical connecting region 34.

The overrun air recirculation valve 10 also has a housing part 21 in which is arranged a holding groove 23 into which the annular body 15 of the blocking element 12 is inserted, as can be seen in detail from FIG. 2.

The housing part 21 also has an underside 24 which points toward the stop plate 19. Arranged on the underside 24 is at least one stop part 22 which can be seen in FIG. 2. Said stop part 22 limits the stroke of the valve sealing head 16 and thereby prevents an abutment of the coil 25 against the iron core 32.

The stop part 22 is preferably of annular design, but can also be composed of a plurality of separate individual parts.

As can also be seen from FIG. 2, the overrun air recirculation valve 10 also has an armature 25 which is arranged in a coil 26. Here, the coil 26 surrounds the armature 25 at the periphery.

The power supply to the coil 26 is ensured by means of an electrical connecting plug 35.

The stop plate 19 is provided with at least one pressure equalizing bore 27 which connects an interior space 28 of the compressor housing 5 to a cavity 29 which is delimited by the cylinder section 17 and by the cone section 18.

The armature 25 of the overrun air recirculation valve is provided with at least one pressure equalizing bore 30 which connects the cavity 29 to a holding space 31 in the overrun air recirculation valve 10.

As can be seen in FIG. 2, the holding space 31 is delimited from the coil 26, the armature 25 and an iron core 32 which is situated opposite said armature 25 at the upper end of the overrun air recirculation valve 10.

A coil spring 33 is arranged in the holding space 31 of the overrun air recirculation valve 10, which coil spring 33 is supported, at its upper end in the illustration in FIG. 2, on the iron core 32, and at the other, lower end, on the armature 25.

To complement the disclosure, reference is explicitly made, in addition to the above written explanations, to the graphic illustration of the invention in FIGS. 1 and 2.

### LIST OF REFERENCE SYMBOLS

1 Turbocharger
2 Turbine housing
3 Compressor
4 Bearing housing
5 Compressor housing
6 Valve flange
7 Compressor inlet
8 Flange surfaces
9 Connecting duct
10 Overrun air recirculation valve
11 Sealing device
12 Blocking element
13 Valve seat surface
14 Sealing lip
15 Annular body
16 Valve sealing head
17 Cylinder section
18 Cone section
19 Stop plate
20 End of 18
20′ End of 18
21 Housing part
22 Stop part
23 Holding groove
24 Underside
25 Armature
26 Coil
27 Pressure equalizing bore
28 Interior space
29 Cavity
30 Pressure equalizing bore
31 Holding space
32 Iron core
33 Coil spring
34 Connecting region
35 Electrical connecting plug

1-13. (canceled)

14. A turbocharger (1)
having a turbine (2), and
having a compressor (3)
which is drive connected to the turbine (2),
which has a compressor housing (5) which has a bypass duct (9) for connecting the compressor outlet to the compressor inlet, and
which has an overrun air recirculation valve (10) which comprises a sealing device (11) which has a blocking element (12) and a valve seat surface (13) which interacts with said blocking element (12),
wherein
the blocking element (12) has a sealing ring with an annular body (15), and
the sealing device (11) has a valve sealing head (16) which has a cone section (18) which tapers, from a cylinder section (17), in the direction of the compressor housing (5).

15. The turbocharger (1) as claimed in claim 14, wherein the blocking element (12) has an annular body (15) on which a sealing lip (14) is arranged so as to point radially inward.

16. The turbocharger (1) as claimed in claim 14, wherein the valve sealing head (16) has a stop plate (19) which adjoins the conically tapered end (20′) of the cone section (18).

17. The turbocharger (1) as claimed in claim 14, wherein a housing part (21) of the overrun air recirculation valve (10) has a holding groove (23) for the annular body (15) of the blocking element (12).

18. The turbocharger (1) as claimed in claim 17, wherein the housing part (21) has an underside (24) which points toward the stop plate (19), on which underside (24) is arranged at least one stop part (22).

19. The turbocharger (1) as claimed in claim 18, wherein the stop part (22) is of annular design.

20. The turbocharger (1) as claimed in claim 14, wherein the overrun air recirculation valve (10) has an armature (25) which is arranged in a coil (26) which surrounds the armature (25) at the periphery.

21. The turbocharger (1) as claimed in claim 16, wherein the stop plate (19) has at least one pressure equalizing bore (27) which connects an interior space (28) of the compressor housing (5) to a cavity (29) of the cylinder section (17) and of the cone section (18).

22. The turbocharger (1) as claimed in claim 21, wherein the armature (25) has at least one pressure equalizing bore (30) which connects the cavity (29) to a holding space (31) in the overrun air recirculation valve (10).

23. The turbocharger (1) as claimed in claim 22, wherein the holding space (31) is delimited from the coil (26), the armature (25) and an iron core (32) which is situated opposite said armature (25).

24. The turbocharger (1) as claimed in claim 23, wherein a coil spring (33) is arranged in the holding space (31), which coil spring (33) is supported at one end on the iron core (32) and at the other end on the armature (25).

25. An overrun air recirculation valve (10) for a turbocharger (1),
having a sealing device (11) which has a blocking element (12) and a valve seat surface (13) which interacts with said blocking element (12), characterized by at least one of the characterizing features of claim 14.
